(19) United States
(12) Patent Application Publication
(10) Pub. No.: US 2001/0001408 A1
(43) Pub. Date: May 24, 2001

(54) METHOD AND APPARATUS TO FEBRICATE A FULY-CONSOLIDATED FIBER- REINFORCED TAPE FROM POLYMER POWDER PREIMPREGNATED FIBER TOW BUNDLES FOR AUTOMATED TOW PLACEMENT

(76) Inventors: HARRY L. BELVIN, HAYES, VA (US); ROBERTO J. CANO, YORKTOWN, VA (US)

Correspondence Address: NATIONAL AERONAUTICS AND SPACE ADMINISTR, ATION LANGLEY RESEARCH CENTER, 3 LANGLEY BOULEVARD, MAIL STOP 212, HAMPTON, VA, 236812199

(21) Appl. No.: 09/185,142

(22) Filed: Nov. 3, 1998

Related U.S. Application Data
(60) Provisional application No. 60/064,109, filed on Nov. 3, 1997.

(51) Int. Cl. B31C 1/00; B65H 81/00

(52) U.S. Cl. 156/181; 156/180; 156/425

(57) ABSTRACT

An apparatus for producing a consolidated, fiber-reinforced composite tape from a plurality of powder pre-impregnated fiber tow bundles having a fiber and a polymeric matrix comprise six (6) major components. Starting at the supply end of the manufacturing line, the components include a pay-out creel, a collimation device, a processing component with an impregnation bar assembly, variable-dimension forming nip-rollers, a self-contained driving mechanism, and a motorized take-up spool. These six components are positioned inoperable relationship to one another. The method of producing the consolidated composite tape includes the steps of: (a) feeding the plurality of the tow bundles through the collimation device to align the tow bundles laterally; (b) heating the tow bundles to a specific processing temperature which melts the polymeric matrix of the tow bundles; (c) spreading the heated tow bundles over the impregnation bar assembly to wet-out the filament array of the heated tow bundles and to form the heated tow bundles to an initial width and shape; (d) re-shaping the heated tow bundles into a pre-determined width by pulling the heated tow bundles through the variable-dimension forming nip rollers; (e) pulling the shaped tow bundles through the self-contained drive mechanism, thereby enabling the polymeric matrix of the shaped tow bundles to consolidate fully into the fiber-reinforced composite tape; and (f) taking-up the consolidated fiber-reinforced composite tape onto the spool.

### ORIGIN OF INVENTION

This invention described herein was made by employees of the United States Government and may be manufactured and used by or for the Government or government purposes without payment of any royalties thereon or therefor.

### CLAIM OF BENEFIT OF PROVISIONAL APPLICATION

Pursuant to 35 U.S.C. §119, the benefit of priority from provisional application Ser. No. 60/064,109 with a filing date of Nov. 3, 1997, is claimed for this non-provisional application.

### BACKGROUND OF THE INVENTION

1. Field of the Invention

The present invention relates generally to a method and an apparatus for manufacturing a fully-consolidated, fiber-reinforced composite tape having a polymeric matrix. More particularly, the invention relates to a method and an apparatus for manufacturing a fully-consolidated, fiber reinforced composite tape from powder pre-impregnated fiber tow bundles for automated tow placement.

2. Description of the Related Art

Reinforcing fibers comprising filaments combined with a matrix resin are known in the art and typically are called “towpregs”. A conventional towpreg consists of thousands of filaments impregnated with a continuous mass of matrix. The type of advanced reinforcing fibers typically used are available commercially in bundles of filaments known as “tows.” The number of filaments vary widely per tow and is denoted by the tow count. Many matrix resins are available, most matrix resin systems fall into one of two resin types within the related art: thermoplastic and thermoset polymers.

Thermoplastic polymers have been used widely as matrices for composites, and are potentially useful as matrices for advanced composites in aerospace applications. Thermoplastics have advantages over thermosetting materials in fracture toughness, impact strength, and environmental resistance. Thermoplastics also provide towpregs with indefinite shelf life, give the fabricator better quality assurance, and avoid the storage and refrigeration problems associated with thermosetting towpreg. Thermoplastic molecules are tougher than the rigid cross-linked network of the thermosets; few of the toughened thermosets have met the combined requirements of damage tolerance and hot/wet compression strength necessary for use in aerospace composites. The disadvantage of thermoplastic polymers as a composite matrix material is the difficulty of uniformly coating the fibers due to the high viscosity of the molten polymer.

Thermoset polymers also are used as matrices for towpreg. Towpreg containing thermosetting prepolymer, although relatively flexible, is tacky, thus requiring a protective release coating, which must be removed before use. While thermoset towpreg is acceptable for filament winding, its tackiness and the requirement of a protective release coating make thermoset towpreg unfeasible for weaving, braiding, or the production of any chopped fiber feed stock for bulk or sheet molding compounds.

Continuous fiber towpregs can be produced by a number of impregnation methods including hot melt, solution, emulsion, slurry, surface polymerization, fiber commingling, film interleaving, electroplating, and dry powder techniques. Powder coating of tow is the most recent method developed in making a powder pre-impregnated fiber tow bundle. The significant advantages of this method include no need for a solvent and no high stress being introduced into the process. The ultimate goal for almost all powder-coating applications is the ability to deposit a thin, even thickness, high quality coating as efficiently as possible. The powdered polymeric matrix or resin also must be solid at ambient and elevated storage temperatures, and be capable of melting sharply to low viscosity to permit flow and to penetrate the fiber tow when heated. Dry powder coating has many advantages because the elimination of a wet base, solvent, or water facilitates the reclamation of the coating material. This reclamation is an important economic advantage which promises a potential full utilization of powder plus elimination of expensive solvents which are flushed off and inevitably wasted. Powder coating has grown largely on these potential benefits.

Typically, towpregs made from powder-coated fiber bundles are not well-characterized geometrically, leading to difficulties in using such towpregs for processes wherein an accurate geometry is vital for the production of high-quality parts. Examples of processes which require an accurate geometry include filament winding, pultrusion, and automated tow placement, or ATP.

ATP is a process where composite ribbons or tapes are robotically managed and continually fed onto a tool or part surface and adhered by application of heat and pressure. ATP is particularly sensitive to the quality of the ribbon when considering low-flow matrix materials. The simultaneous assembly of adjacent ribbons (typically 4 to 34) or wide tape offers significant advances in the lay-up of composite materials. However, ribbons or tapes made from low-flow matrix materials typically lack a cross-sectional dimensional integrity, and more importantly, a standard rectangular cross-section. These structural defects complicate the ATP process and frequently render poor results. Although ribbons are bonded to their vertical neighbor (directly below) satisfactorily, the failure to make quality parts is generally attributed to the poor bonding of adjacent ribbons to each other. Low-flow thermoplastic parts made by using slit prepreg tapes are typically unconsolidated and exhibit excessive porosity and void content.

Ideally, tapes used in the ATP process should be fully consolidated. Consolidation can be defined as the elimination of voids in a composite material during melt-processing. One method of accomplishing consolidation is pultrusion. This technique requires full ingestion of the unconsolidated composite material within an enclosed die with an exit area less than the inlet area. Within the heated closed die, processing of the polymeric matrix forces the polymer melt to flow axially to the filament array, whereas flow transverse to the filament array is generally 1/10 to 1/100 of the axial flow. As a consequence of the geometry and boundary limits of the pultrusion die, voids must be expelled axially, against the flow of the composite material via the entrance of the pultrusion die. This complex flow of voids is known to limit the rates at which pultrusion may proceed. With the desirable prepreg attribute of low void content, the pultrusion process is limited in the length of the die because the longer the die, the longer the voids must travel to be fully expelled. This length contributes to a very slow production rate.

In U.S. Pat. No. 4,680,224 to O'Conner, a pultrusion process is disclosed wherein a poly(arylene sulfide) polymer matrix system is consolidated. O'Conner specifies pultruding powder-impregnated glass rovings and pultruding aqueous slurry impregnated fiber strands with a commercially available pultrusion apparatus, achieving a production rate of 15 cm/minute. O'Conner states that a major operational problem of pultrusion is encountered at the die entrance, wherein fiber jamming was explained to cause catastrophic failure of the pultrusion process.

U.S. Pat. No. 2,702,408 to Hartland discloses a pultrusion apparatus having two separate dies, with one heated and the other cooled. U.S. Pat. No. 4,820,366 to Beever et al. discloses the further development of this concept to include a means of impregnation of dry filaments. However, this process is deficient because the process must be stopped occasionally to open the cooling die, massage the material, and remove fiber balls.

O'Conner in U.S. Pat. No. 4,883,552 discloses a pultrusion process wherein ¼ inch diameter carbon fiber rods made from a carbon filament array slurry powder impregnated with polyphenylene sulfide polymer is pultruded. Production rates were noted at 15 inches per minute which are considered to be very slow.

Muzzy et al. in U.S. Pat. Nos. 5,296,064 and 5,409,757 disclose a flexible, multiply towpreg tape made from powder-coated towpreg and a three-step process for producing this tape. This process includes (1) coating reinforcing filaments with a matrix-forming material to cause interfacial adhesion; (2) heating the matrix-forming material until it liquefies and coats the filaments to form a fusion-coated towpreg; and (3) passing the fusion-coated towpreg through a forming means of known geometry to form a fusion-coated towpreg tape. However, the actual dimensional tolerances are not clear.

Sandusky in U.S. Pat. No. 5,395,477 discloses an apparatus and method for providing a uniform, consolidated, unidirectional, continuous, fiber-reinforced composite ribbon. The apparatus includes a pre-melting chamber, a stationary bar assembly, and a loaded, cooled nip-roller apparatus. Examples given by Sandusky discuss the manufacture of a ribbon having a width of 0.250 in. and the direct correlation to a tape having a width of three (3) inches.

Sandusky employs a number of techniques which make the fabrication of a fully consolidated 3-inch wide tape improbable. First, the single piece roller design leads to the fabrication of material with a fixed cross-section. Without the compliance of a variable cross-section, a precise uniform-shaped tape or ribbon will only be produced if enough composite material is fed through the forming device to fill the fixed opening. During periods when the powder content of the fiber tow drops below the desired amount, the shape of the tape or ribbon becomes very irregular and jagged, which facilitates the generation of voids. The lack of a smooth uniform surface and a large void content inhibits the automated tow placement process during final fabrication of a structure with the tape or ribbon.

Second, when the pre-melting chamber operates at elevated temperatures, its atmosphere, which comprises mainly oxygen, facilitates the creation of an oxidized layer on the surface of the heated tape or ribbon. This layer will inhibit the positioning of the tape or ribbon during the ATP process and create delaminations in the final product.

Third, Sandusky lacks a collimation device for maintaining the orientation of each individual fiber tow bundle. Such a device is essential in the manufacture of a uniform product with respect to thickness. If the individual tows are out of alignment they can overlap and create a tape which is not a consistent thickness across the width. During ATP, a tape or ribbon with a thickness differential across its width makes pressure application difficult and may initiate the manufacture of structural parts of non-uniform shape and dimension.

Fourth, the lack of a dedicated drive component for the line is a critical problem The tows need to maintain a zero speed differential across the width of the tape during processing. If the individual tows are moving at differing velocities, the tape will never combine and consolidate. This anomaly creates splits and gaps which make it virtually impossible to process in an ATP robot.

### SUMMARY OF THE INVENTION

Accordingly, an object of the present invention is to manufacture a fully consolidated fiber-reinforced composite tape from powder pre-impregnated tow bundles.

Another object is to manufacture a composite tape of consistent thickness across its width.

A further object of the invention is to manufacture a composite tape suitable for automated tow placement.

Another object of the invention is to manufacture a fully-consolidated composite tape without an oxidized layer.

Still another object of the present invention is to manufacture a composite tape having geometric accuracy regardless of changes in the powder content along the length of the fiber tow bundles.

The above and other objects of the invention are attained, at least in part, by providing a method and apparatus for producing a consolidated, fiber-reinforced composite tape from a plurality of powder pre-impregnated fiber tow bundles having a fiber and a polymeric matrix. The apparatus to manufacture a fully-consolidated composite tape from powder pre-impregnated tows for ATP comprises six (6) components. Starting at the supply end of the manufacturing line, the components include a pay-out creel, a collimation device, a processing component with a stationary bar assembly, a variable-dimension forming nip means, a self-contained driving means, and a take-up component.

The method for manufacturing the composite tape begins with the pre-impregnated fiber tow bundles being mounted onto the pay-out creel for delivery. The spools of tow bundles are individually tensioned at this point to facilitate the alignment of the filaments of each bundle. This tension also adds in the spreading of the bundles in the processing component. The tow bundles are then fed through the collimation device to maintain the alignment of the individual tow bundles during processing. The collimation device facilitates the consistent thickness across the width of the processed material. If the alignment changes, a tape or ribbon will be fabricated of irregular shape and should not be later used with the ATP process.

This alignment facilitates the forming of the molten pre-preg or polymeric matrix into a precise shape and dimension. The bundles then proceed through the processing component. The processing component comprises two parts, an oven or furnace and an impregnation or stationary bar assembly. The oven is heated to a specific processing temperature for each individual polymeric matrix depending on the powdered resin of the tow bundle. Preferably, when processing requires a high temperature to melt the polymeric matrix material, an inert gas such as nitrogen is used as a process medium inside the oven to induce melting without oxidation. While still inside the oven, the tow bundles are pulled through the impregnation bar assembly. The bars facilitate the wetting out of the filaments of the tow bundles and aid in the initial spreading of the tow bundles to a selected width and shape. The tension which is created back at the pay-out creel is instrumental in this spreading process, with greater tension further assisting the spreading of the fiber tow.

Upon exiting the process component, the molten tow bundles are fed through the variable dimension forming nip means. The variable dimension forming nip means cools the molten tow bundles and shapes them into a precise, predetermined width. Preferably, the invention uses nitrogen as the cooling medium. Additionally, because the variable dimension forming nip means do not have a defined gap between the two rollers, the rollers allow for changes in powder content along the fiber tow bundle during processing by varying the cross-section along the length of the composite tape. Powder content can vary along the length of the towpreg as much as ±8% depending on the type process used to coat the clean tow bundles.

The next component is the self-contained driving means. The self-contained driving means pulls the total number of bundles needed to fabricate the tape through the process. The driving means maintains the speed of the process and removes any speed differential between the individual tow bundles. This constant speed in turn eliminates a shearing force which would facilitate gaps and splits in the finalized tape. Thus, the driving means allows the resin content of the bundles to flow together. As a result, the method produces a fully-consolidated composite tape, which is spooled by a motorized take-up system.

Additional objects, advantages, and novel features of the invention will be set forth in part in the description which follows, and in part will become the apparent to those skilled in the art upon examination of the following or may be learned by practice of the invention. The objects and advantages of the invention may be realized and attained by means of the instrumentalities and combinations particularly pointed out in the claims.

### BRIEF DESCRIPTION OF THE DRAWINGS

FIG. 1 is a side view of an apparatus for manufacturing a fiber-reinforced composite ribbon according to the prior art;

FIG. 2 is a side view of the apparatus and demonstrates the method of manufacture in accordance to the present invention;

FIG. 3 is a front view of a variable height collimation device in accordance to the present invention;

FIG. 4 is a front view of an alternative embodiment of the collimation device of the present invention;

FIG. 5 is side view of the processing component of the present invention;

FIG. 6A is a side view of the bar assembly of the present invention;

FIG. 6B is a top view of the bar assembly of the present invention;

FIG. 7 is a front view of the variable-dimension shaping means of the present invention;

FIG. 8: is a front view of the self-contained driving means of the present invention;

FIG. 9 is a SEM of the fracture surface of PIXA-M 7.6 cm (3 in)-wide tape made in accordance to the method of the present invention; and

FIG. 10 is a photomicrograph of a cross-section of PIXA-M 7.6 cm (3 in)-wide tape made in accordance to the method of the present invention.

### DESCRIPTION OF THE PREFERRED EMBODIMENTS

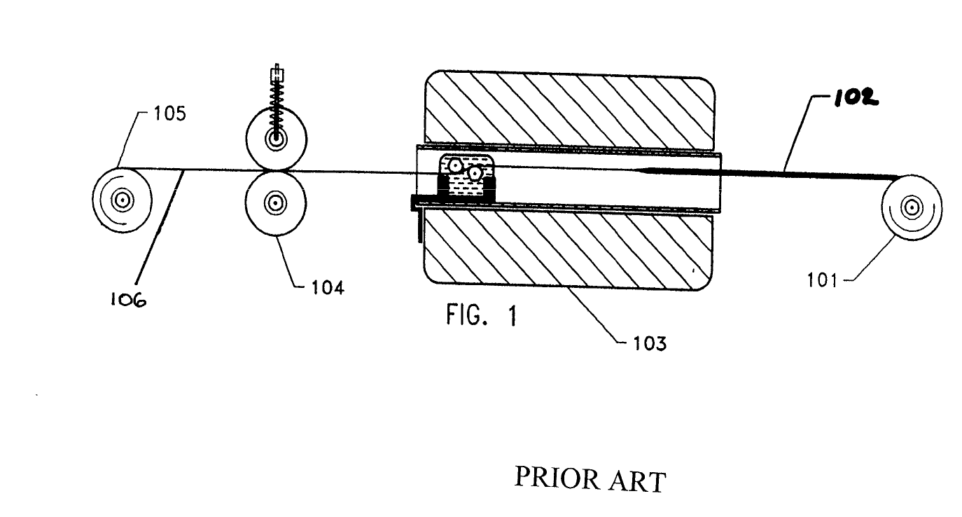

The present invention is an improvement of an apparatus for and method of manufacturing a uniform, consolidated, unidirectional continuous fiber-reinforced composite ribbon. FIG. 1 illustrates the prior art as given by Sandusky in U.S. Pat. No. 5,395,477, which is hereby incorporated by reference. As shown in FIG. 1, a supply means 101 delivers the incoming unidirectional, continuous, filament reinforced polymeric pre-impregnated material 102. The towpreg material is pulled through the forming means 103 and the shaping means 104 by the take-up means 105. The method produces a consolidated ribbon 106.

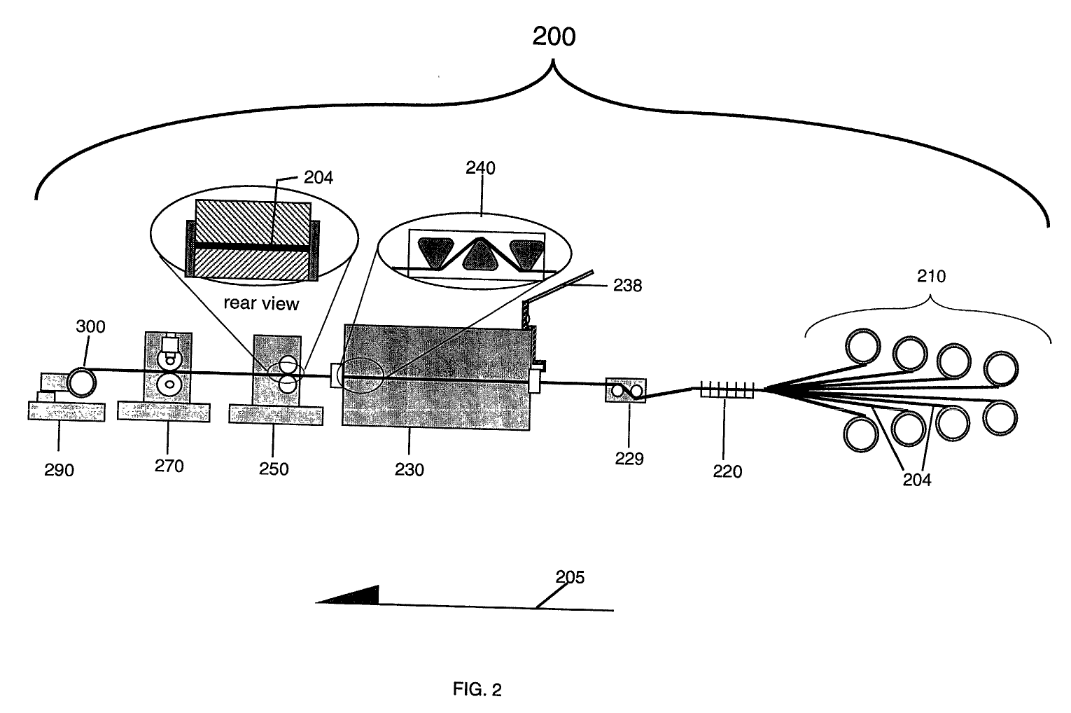

Referring now to FIG. 2, an apparatus 200 for producing a fully consolidated, fiber-reinforced tape 300 from a plurality of powder pre-impregnated fiber tow bundles 204, or towpregs, in accordance to the present invention, is generally shown. The apparatus comprises six major components: a pay-out creel 210, a collimation means 220, a processing component 230, a variable-dimension forming nip means 250, a self-contained driving means 270, and a taking-up means 290. Each major component is positioned in operable relationship to its neighboring component. The direction of the process is shown by the vector 205.

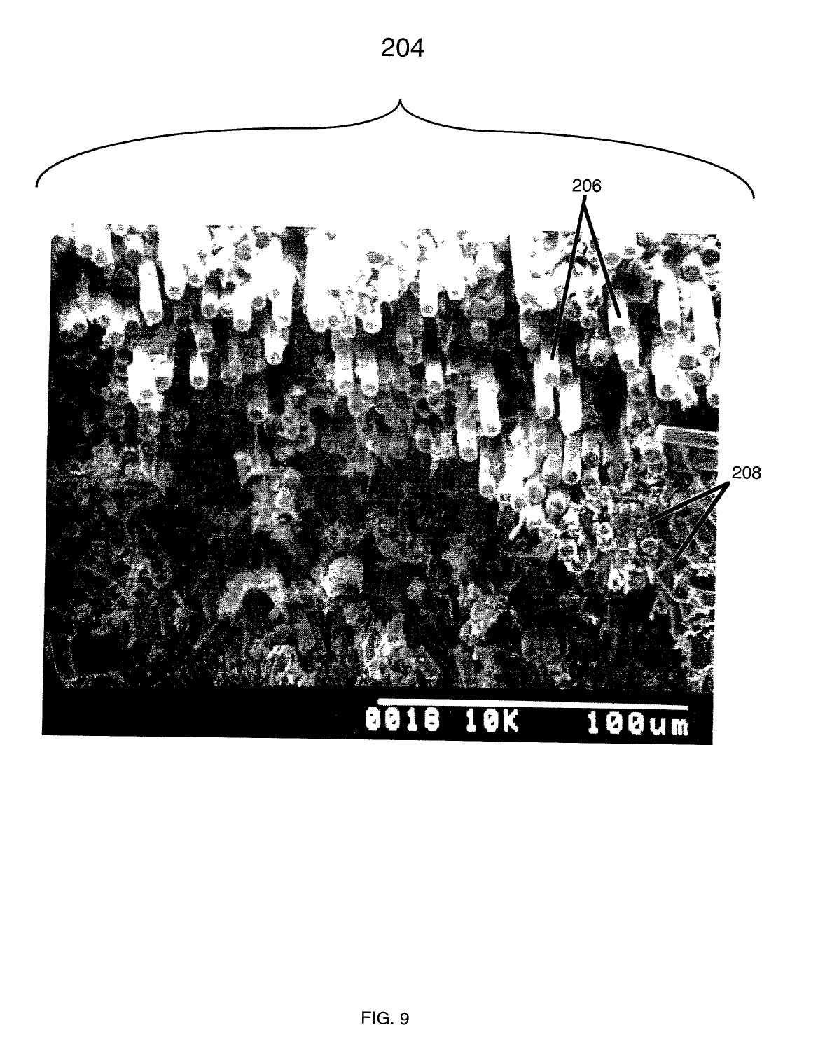

The process of this invention begins by mounting a plurality of powder pre-impregnated fiber tow bundles 204 onto the pay-out creel 210 for delivery to the collimation means 220. As is well known in the art and also generally represented in FIG. 9 (although after consolidation has occurred), each fiber tow bundle 204 comprises a plurality of continuous filament arrays 206 (typically composed of 6,000 to 12,000 filaments) which have been previously impregnated with some melt-processible polymeric matrix 208. Impregnation methods include: 1) dry-powder prepregging, 2) water-slurry powder prepregging, 3) solution dip-pan prepregging, and 4) hot-melt prepregging. Before beginning the process of this invention, the powder pre-impregnated fiber tow 204 is partially unconsolidated with some volume percentage occupied by air or other gaseous voids. The voids are a consequence of the towpreg quality and type of manufacturing technique and are commonly accepted to occupy a range of shapes (spheres and slugs) and sizes (1 to 100 filament diameters). Expulsion of these voids while fabricating a composite tape for automatic tow placement is a primary objective of this invention.

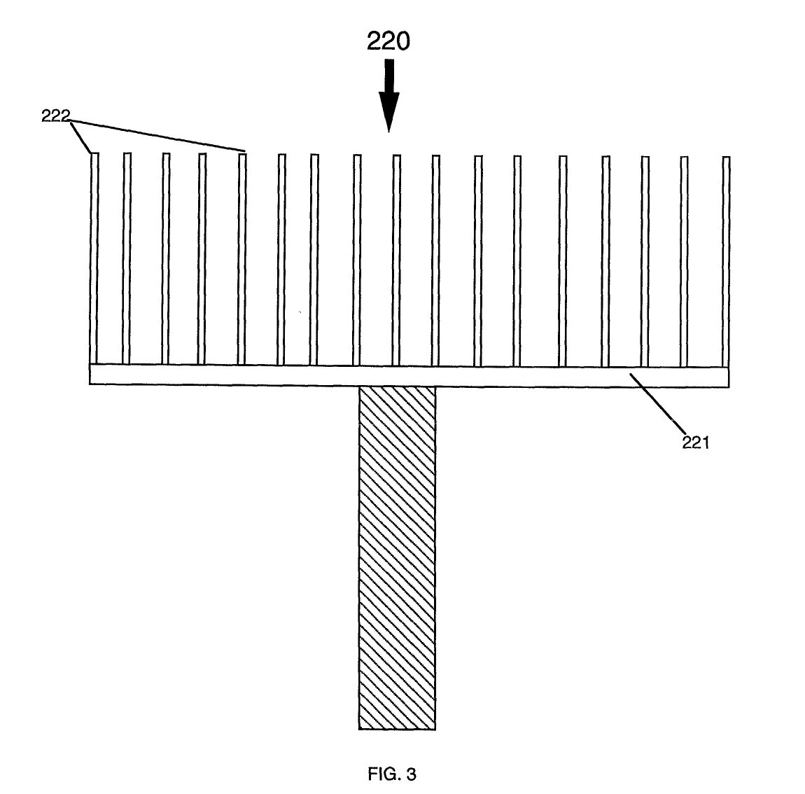

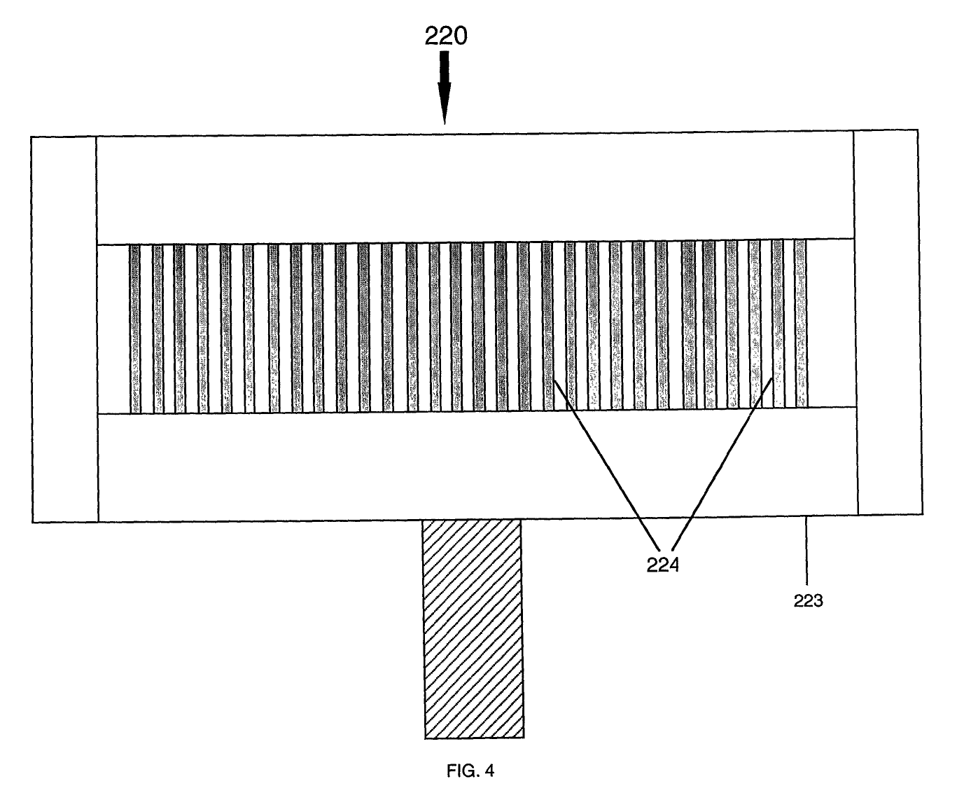

Referring now to FIG. 3, one embodiment of the collimation means 220 is a variable height collimation device comprising a comb 221 having a plurality of teeth 222. Alternatively, as illustrated in FIG. 4, the collimation means 220 may embody a low-friction collimation device which comprises a frame 223 having a plurality of rotating ceramic bars or spindles 224. The collimation means 220 aligns the fiber tow bundles 204 laterally during processing and also maintains this alignment, which facilitates a consistent thickness across the width of the processed material.

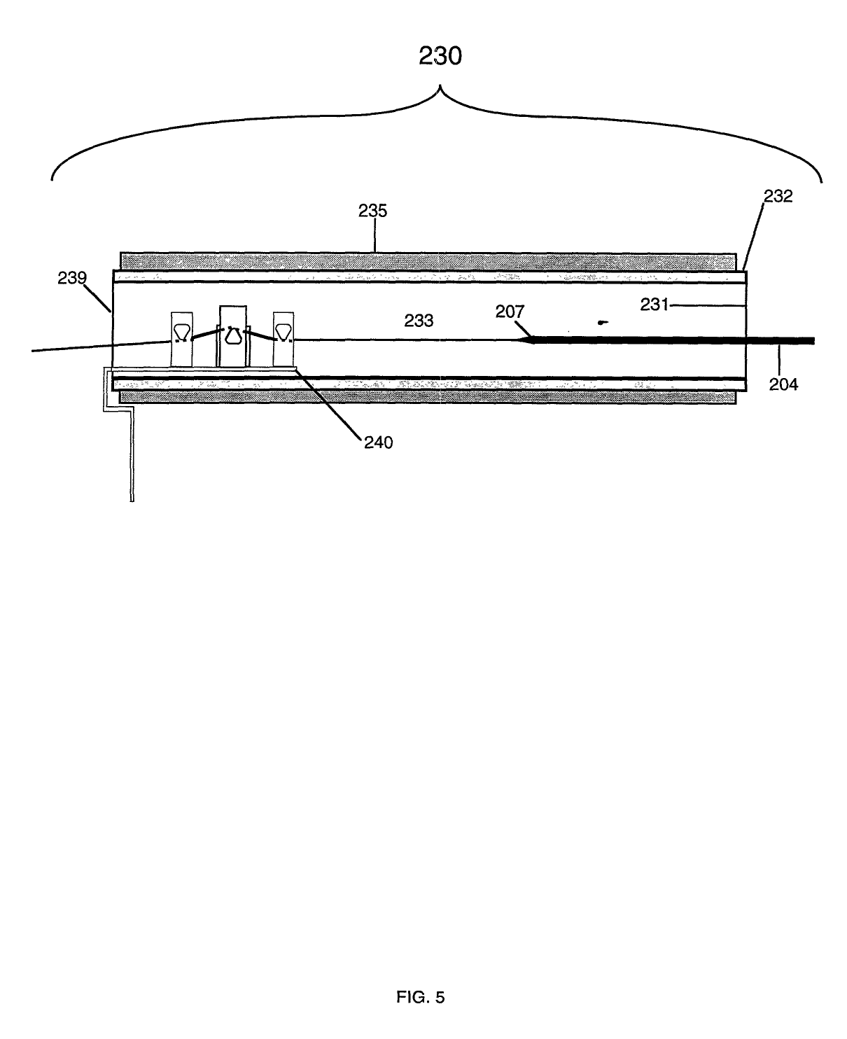

The process continues as shown in FIG. 2 with the fiber tow bundles 204 passing through a set of air rollers 229 and entering the processing component 230. Referring now to FIGS. 2 and 5, the processing component 230 comprises a melting chamber 233 and an impregnation bar assembly 240, both of which are housed within a tube furnace or oven 235 having a steel tube liner 232. The oven 235 is heated to a specific processing temperature for each individual polymeric matrix depending on the powdered resin of the tow bundle. Preferably, when processing requires a high temperature to melt the polymeric matrix material, an inert gas such as nitrogen, supplied by a gas line 238 as indicated in FIG. 2, is used as a process medium inside the oven to induce melting without oxidation. Also preferably, the oven comprises a three-zone furnace with a steel liner. However, any oven which raises the temperature in the melting chamber 233 to the melting point of the polymetric matrix will suffice.

The melting chamber 233 is located within and is first encountered at the entrance 231 to the oven. Within the melting chamber 233, the polymeric matrix of the prepreg material 204 melts from the solid phase to a viscous liquid phase, which causes a liquid wetting phenomenon, reducing the void content and resulting in a slight neck-down region 207 on the prepreg material. The continuous filament array component of the prepreg material 204 remains solid and continues to support 100% of the pulling tension. Near the exit 239 of the oven 235 is the impregnation bar assembly 240.

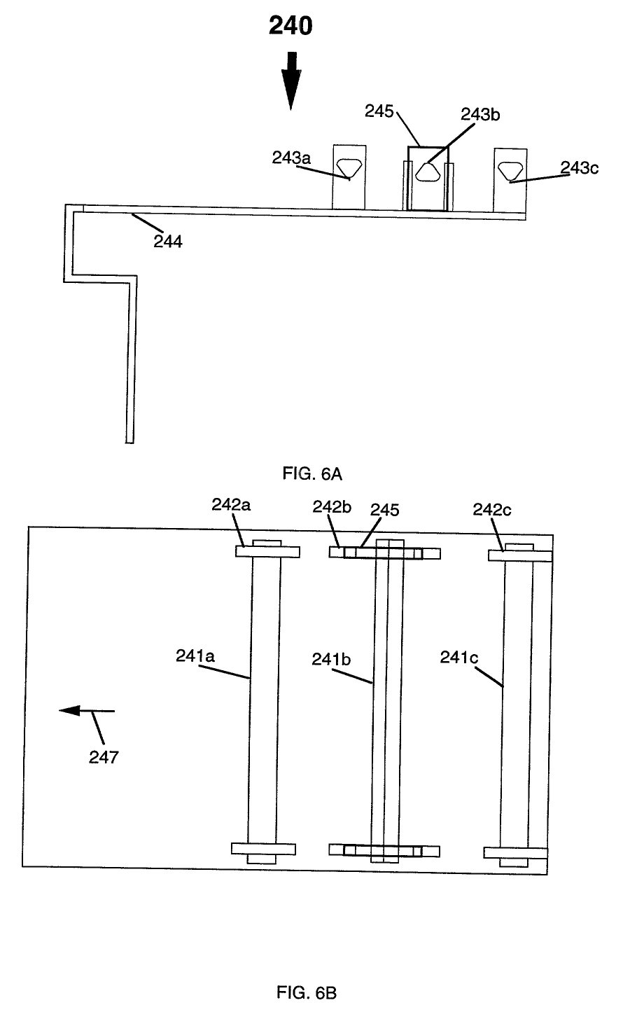

Referring now to FIGS. 6A and 6B, the impregnation bar assembly 240 comprises a bar fixture 244, a plurality of bar uprights 242a, 242b, 242c, and a plurality of stationary bars 241a, 241b, 241c fixed substantially perpendicular to the axial direction of the fiber tow bundles, which is represented by the vector 247. Preferably, the number of stationary bars is three and the cross-sectional shape of each bar is substantially triangular. Each bar 241a, 241b, 241c is oriented sequentially in series to the direction 247 of the tow bundles. The tow bundles are pulled through the impregnation bar assembly 240 in such a manner as that each bar contacts the tow bundles at a cross-sectional apex 243a, 243b, 243c of each bar. Either sequential pathway of the tow bundles through the bars, under-over-under (shown), or over-under-over (not shown), will produce a good result. The impregnation bar assembly 240 further comprises an adjustable bar holder 245, which adjusts the height of the middle bar 241b relative to the other two bars 241a and 241c. The height of the middle bar 241b remains stationary during the course of the manufacturing process. Changing the height of the middle bar effectively changes the wrap angle of the impregnation bar assembly 240.

The bars may be constructed of materials which maintain structural integrity at temperatures above the processing temperature of the polymeric matrix of the prepreg material. Some examples of materials which may be used for the bars include: polished quartz, bulk carbon graphite, and ceramic such as partially stabilized zironia (PSZ). The geometry of the bars and the bar uprights controls the resulting pressure gradients which are applied to the prepreg material by the impregnation bar assembly 240. The geometry can be adjusted to affect the pressure gradients. Examples of such adjustments and the effects include: 1) increasing the bar surface curvature radius decreases the applied pressure gradients; 2) increasing the center line distance between each contact radius center of each stationary bar decreases the applied pressure gradients; 3) increasing the wrap angle defined by the center line and the fiber tow bundle increases the applied pressure gradients. The application of these pressure gradients allows for the expulsion of voids and the re-distribution of the polymeric matrix and the filaments, a process known in the art as wetting-out. This process causes the heated fiber tow bundles to begin forming into a consolidated, wide, flat shape.

After the heated fiber tow bundles exit the impregnation bar assembly 240, the polymeric matrix of the prepreg material is in a transition from a viscous liquid to a state described as a malleable plastic solid. The heated fiber tow bundles 204 then enter the variable-dimension forming nip means 250. As shown in FIG. 2, the forming nip means 250 is placed in an operable relationship to the processing component 230. This relationship allows enough distance from the processing component 230 for the polymeric matrix to remain molten upon entrance into the forming nip means.

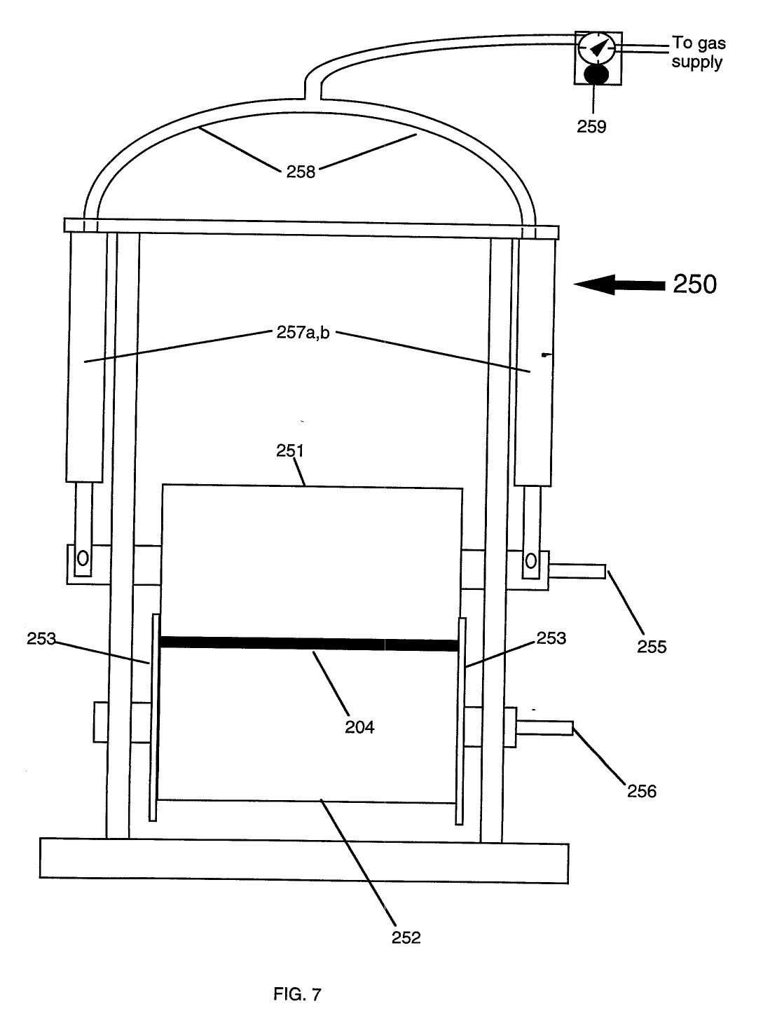

As indicated in FIG. 7, the variable-dimension forming nip means 250 is a variably-loaded, surface-cooled nip-roller apparatus. The forming nip means comprises two nip-rollers 251, 252 whose surfaces are actively cooled under forced convection via load bearing shafts 255,256 which are connected to a cooling medium. Preferably, the cooling medium is nitrogen. A variable-loading means 257a, 257b variably loads the floating roller 251 against the fixed roller 252. Preferably, the variable loading means 257a, 257b is a pair of pneumatic air cylinders connected to an air line 258. A pressure regulator 259 selects and adjusts the consolidation pressure exerted by the rollers 251, 252 onto the heated tow bundles 204. Alternatively, other types of loads, such as a spring load, may also be employed. The variable loading allows for passing of anomalies, such as filament balls, in the heated fiber tow bundles. More importantly, because the nip rollers 251, 252 do not have a defined gap between them, the rollers allow for a variable thickness of the heated fiber tow bundles along their length. This variable thickness along the length of the fiber tow bundle occurs because of changes in powder content, which can vary as much as ±8% depending on the type of process used for coating.

Under the load applied by the loaded nip-rollers 251, 252 and the thermal gradient imposed by the cool roller surfaces, the molten plastic undergoes transition to a solid elastic state and the heated fiber tow bundles are shaped to a precise width as determined by the location of flanges 253, which connect to the ends of the fixed roller 252. An advantage to having the nip-rollers cool is that no release paper is required. The hot sticky polymer melt is quickly solidified (1/10 to 1/1000 second) on contact with the cool nip-rollers. The space between the flanges 253 which is used to form the final width of the consolidated composite tape may be dimensioned for a variety of widths. As later indicated in the Examples given below, a spacing of three inches provided excellent results, although any width could be fabricated. The shaped fiber tow bundles are consolidated and their cross-section is uniform along their length and width.

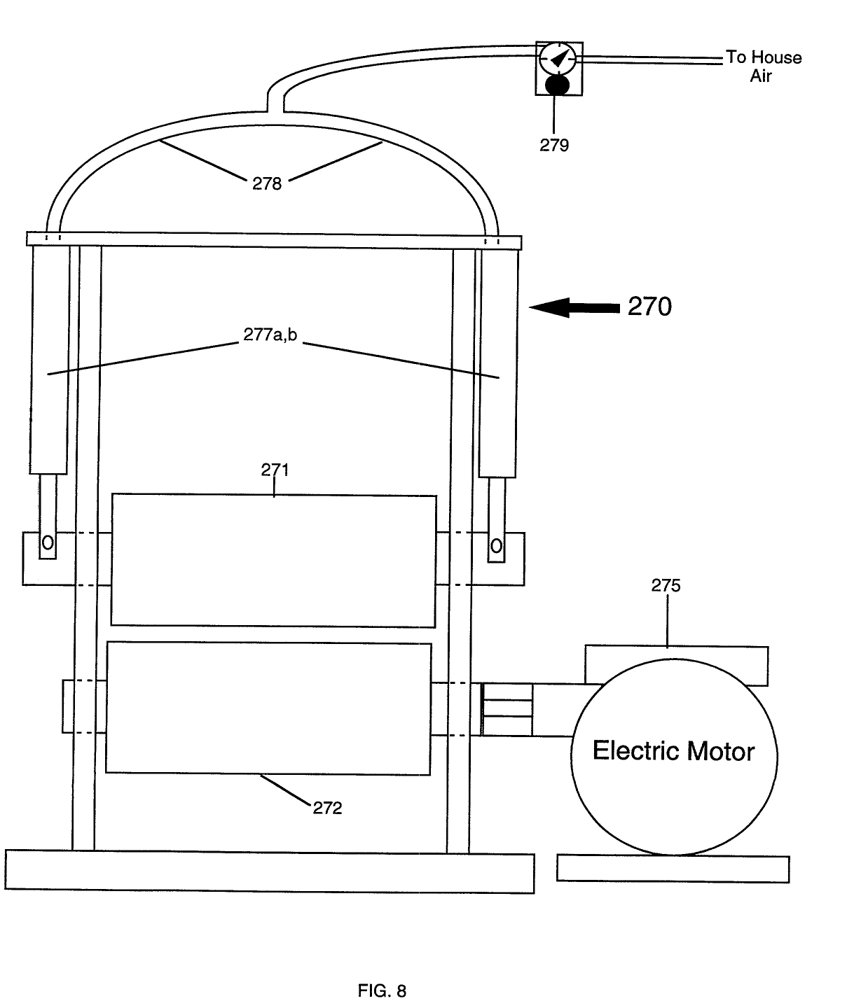

Referring now to FIG. 8, a self-contained driving means 270 comprises a pair of opposing rollers 271, 272, an electric motor 275, and a pair of variable loading means 277a, 277b. The variable-loading means 277a, 277b variably loads the floating roller 271 against the fixed roller 272. Preferably, the variable loading means 277a, 277b is a pair of pneumatic air cylinders connected to an air line 278. A pressure regulator 279 selects and adjusts the consolidation pressure exerted by the rollers 271, 272 onto the consolidated, composite tape 300. Alternatively, other types of loads, such as a spring load, may also be employed.

The self-contained driving means 270 pulls the total number of tow bundles needed to fabricate the composite tape 300 through the process and also maintains a constant speed for the process by eliminating any speed differential cross-sectionally between the individual tow bundles. Any differential in speed between individual tows will cause gaps and splits in the tape to occur. Thus, this constant speed further assists the molten polymeric matrix of the tow bundles to flow together better over greater widths than processes given by the prior art. As shown in FIG. 2, the process finishes with a fully-consolidated composite tape 300, which is spooled by the motorized taking-up means 290.

The process of this invention manufactured fully-consolidated composite tapes from various towpregs, including the thermoplastics PIXA and PIXA-M and the lightly cross-linking thermoplastics, LaRC™PETI-5 and LaRC™PETI-5 [LV121]. Other materials that are able to be processed on the line include almost all thermoplastics and thermosets, including epoxies and bismaleimides.

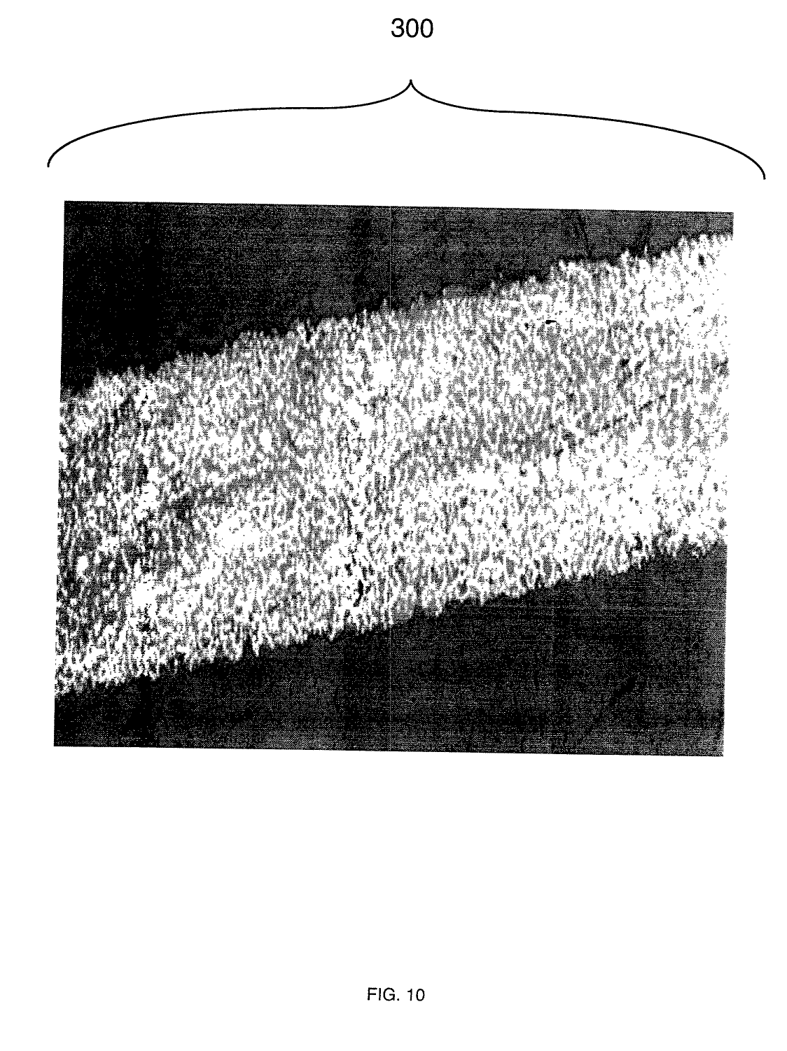

A magnified view, provided by a Scanning Electron Microscope (SEM), of the cross-sectional fracture surface of a composite tape made in accordance to the present invention as shown in FIG. 9 indicates the fibers to be well wet-out. A photomicrograph of the cross section of the composite tape 300 as shown in FIG. 10 demonstrates a void fraction of less than one percent. These results verify the composite tapes manufactured by the method of the present invention was of excellent quality. These tapes may be used by an automated tow placement robot for forming composite parts.

The novel features of the present invention include: (1) a collimation means for aligning the tow bundles laterally and producing a tape of consistent thickness across its width; (2) a processing component which uses inert gas as a processing medium; (3) an impregnation means comprising three triangular-shaped ceramic bars with an adjustable bar holder for varying wrap angle; (4) a variable-dimension forming means which accommodates for changes in the powder content of the fiber tow; and (5) a self-contained driving means which maintains a constant speed cross-sectionally across the plurality of fiber tow bundles.

The following are examples which illustrate the apparatus and method of the present invention. These examples are merely illustrative and intended to enable those skilled in the art to practice the invention in all of the embodiments flowing therefrom, and do not in any way limit the scope of the invention as defined in the claims.

### EXAMPLE 1

The apparatus and method of the present invention was used to convert a fully imidized polyimide powder slurry-coated 12K carbon towpreg into a uniform, solid, consolidated, unidirectional, continuous, polymeric composite tape.

The fully imidized polyimide slurry powder coated carbon towpreg, specifically 12K IM 7/PIXA, which is available in research quantities from Cytec Engineering Materials, was provided. No solvents, plasticizers, or other flow enhancing additives were used in this process. The impregnation bar assembly geometry was defined as having a wrap angle of 83° with a height above centerline of the stationary bar holder of 0.925 inches. The stationary bars were constructed of partially stabilized zironia (PSZ). The bar surface temperature was 440° C., which was achieved by passive heating from the processing component and was stabilized within 10 minutes. The cooled, forming nip-roller apparatus was cooled by forcing gaseous nitrogen through a dry ice and acetone bath and then into the forming component at 20 PSI. The consolidation pressure was applied with pneumatic cylinders and was maintained at 122 pounds of force. The spacing of the flanges on the forming nip means allowed for a finished part with a cross-section defined by 3 inches wide by 0.005 inches thick. The take-up rate was set at a constant 30 feet per minute. The towpreg was threaded through the apparatus and the tension applied to the towpreg yarn at the creel was set to 200 grams. The resulting tape was of excellent quality and consistency along its entire length. A test quantity of tape was produced. In general, the tape seemed well-consolidated and broke cleanly (a test for consolidation quality.) In the initial runs with twenty-five (25) tows, tape width varied from 7.52 cm (2.96 in) to 7.62 cm (3.00 in). Thickness across the width ranged from 0.152 mm (0.005 in.) to 0.178 mm (0.007 in.). Upon clean-up, it was observed that no surface abrasion had damaged the stationary bars, which allowed them to be reused.

### EXAMPLE 2

Again, the apparatus and process of the present invention was used to convert a fully imidized polyimide powder slurry-coated 12K carbon towpreg into a uniform, solid, consolidated, unidirectional, continuous, polymeric composite tape.

The fully imidized polyimide slurry powder coated carbon towpreg, specifically 12K IM7/PIXA-M, which is available in research quantities from Cytec Engineering Materials, was provided. No solvents, plasticizers, or other flow enhancing additives were used in this process. The impregnation bar assembly geometry was defined as having a wrap angle of 72° with a height above centerline of the stationary bar holder of 0.8 inches. The stationary bars were constructed of partially stabilized zironia (PSZ). The bar surface temperature was 380° C., which was achieved by passive heating from the processing component and was stabilized within 10 minutes. The cooled, forming nip-roller apparatus was cooled by forcing gaseous nitrogen through a dry ice and acetone bath and then into the forming component at 20 PSI. The consolidation pressure was applied with pneumatic cylinders and was maintained at 122 pounds of force. The spacing of the flanges on the forming nip means allowed for a finished part with a cross-section defined by 3 inches wide by 0.005 inches thick. The take-up rate was set at a constant 25 feet per minute. The towpreg was threaded through the apparatus, with the tension applied to the towpreg yarn at the creel set to 200 grams. The resulting tape was of excellent quality and consistency along its entire length. Approximately 5.45 kg (12 lbs) of 7.62 cm (3.00 in)-wide tape were produced. In general, the tape seemed well-consolidated and broke cleanly. In the initial runs with twenty-five (25) tows, tape width varied from 7.52 cm (2.97 in.) to 7.62 cm (3.00 in.). Thickness across the width ranged from 0.152 mm (0.005 in.) to 0.178 mm (0.007 in.). Upon clean-up, it was observed that no surface abrasion had damaged the stationary bars, which allowed them to be reused.

### EXAMPLE 3

The apparatus and method of the present invention was used to convert a fully imidized polyimide powder slurry-coated 12K carbon towpreg into a uniform, solid, consolidated, unidirectional, continuous, polymeric composite tape.

The fully imidized polyimide slurry powder coated carbon towpreg, specifically 12K IM 7/LaRC™PETI-5 [LV121], which was powder-coated by Cytec Engineering Materials, was provided. The impregnation bar assembly geometry was defined as having a wrap angle of 84° with a height above centerline of the stationary bar holder of 0.925 inches. The stationary bars were constructed of partially stabilized zironia (PSZ). The bar surface temperature was 480° C., which was achieved by passive heating from the processing component and was stabilized within 10 minutes. The cooled, forming nip-roller apparatus was cooled by forcing gaseous nitrogen through a dry ice and acetone bath and then into the forming component at 20 PSI. The consolidation pressure was applied with pneumatic cylinders and was maintained at 122 pounds of force. The spacing of the flanges on the forming nip means allowed for a finished part with a cross-section defined by 3 inches wide by 0.005 inches thick. The take-up rate was set at a constant 20 feet per minute. The towpreg was threaded through the apparatus, with the tension applied to the towpreg yarn at the creel set to 200 grams. The resulting ribbon was of excellent quality and consistency along its entire length. Approximately 5.45 kg (12 lbs) of 7.62 cm (3.00 in)-wide tape were produced. The tape seemed well-consolidated and broke cleanly. In the initial runs with twenty-seven (27) tows, tape width varied from 7.52 cm (2.96 in.) to 7.62 cm (3.00 in.). Thickness across the width ranged from 0.152 mm (0.0055 in.) to 0.178 mm (0.0075 in.). Upon clean-up, it was observed that no surface abrasion had damaged the stationary bars, which allowed them to be reused.

The invention can be practiced in other manners than are described herein without departing from the spirit and the scope of the appended claims.

We claim:

1. A method of producing a consolidated, fiber-reinforced composite tape from a plurality of powder pre-impregnated fiber tow bundles, each fiber tow bundle having a filament array and a polymeric matrix, comprising:
(a) feeding the plurality of the tow bundles through a collimation device to align the tow bundles laterally;
(b) heating the tow bundles to a specific processing temperature which melts the polymeric matrix of the tow bundles;
(c) spreading the heated tow bundles over an impregnation bar assembly to wet-out the filament array of the heated tow bundles and to form the heated tow bundles to an initial width and shape;
(d) re-shaping the heated tow bundles into a pre-determined width by pulling the heated tow bundles through a variable dimension forming nip;
(e) pulling the shaped tow bundles through a self-contained drive mechanism, thereby enabling the polymeric matrix of the shaped tow bundles to consolidate fully into the fiber-reinforced composite tape; and
(f) taking-up the consolidated fiber-reinforced composite tape onto a spool.

2. The method of producing a consolidated, fiber-reinforced composite tape as in claim 1 further comprising mounting the plurality of powder pre-impregnated fiber tow bundles on a pay-out creel for delivery to the collimation device.

3. The method of claim 1 wherein the powder pre-impregnated fiber tow bundles are heated in a processing component with an inert gas.

4. The method of claim 3 wherein the inert gas is nitrogen.

5. The method of claim 1 wherein the pre-determined width of the composite tape is three inches.

6. An apparatus for producing a consolidated, fiber-reinforced composite tape from a plurality of powder pre-impregnated fiber tow bundles, each fiber tow bundle having a filament array and a polymeric matrix, comprising:
(a) a pay-out creel for delivering the plurality of powder pre-impregnated fiber tow bundles to a collimation device;
(b) a collimation device, positioned in operable relationship to the pay-out creel, for aligning the tow bundles laterally;
(c) a processing component, positioned in operable relationship to the collimation device, for heating the tow bundles to a specific processing temperature which melts the polymeric matrix of the tow bundles, said processing component having an entrance and an exit, said processing component including an impregnation bar assembly positioned near the exit of the processing component for wetting-out the filament array of the heated tow bundles and for spreading the heated tow bundles to an initial width and shape;
(d) a variable dimension forming nip means, positioned in operable relationship to the processing component, for shaping the heated tow bundles into a predetermined width;
(e) a self-contained driving means, positioned in operable relationship to the variable dimension forming nip, for pulling the shaped tow bundles, said self-contained drive mechanism maintaining a constant speed across the width of the shaped tow bundles, thereby enabling the polymeric matrix of the shaped tow bundles to consolidate fully into the composite fiber-reinforced tape; and
(f) means for taking-up the consolidated, fiber-reinforced composite tape.

7. An apparatus for producing a consolidated, fiber-reinforced tape as given in claim 6, wherein the processing component includes an inert gas supply line for supplying an inert gas as a process medium.

8. An apparatus for producing a consolidated, fiber-reinforced tape as given in claim 7, wherein the inert gas is nitrogen.

9. An apparatus for producing a consolidated, fiber-reinforced tape as given in claim 6, wherein the variable-dimension forming nip means comprises two opposing rollers being forced together by a variable-loading means.

10. An apparatus for producing a consolidated, fiber-reinforced tape as given in claim 9, wherein the variable loading means is a pair of pneumatic air cylinders.

11. An apparatus for producing a consolidated, fiber-reinforced tape as given in claim 10, wherein the two opposing rollers use a cooling medium to provide a cool surface along the surface of each roller.

12. An apparatus for producing a consolidated, fiber-reinforced tape as given in claim 11, wherein the cooling medium is nitrogen.

13. An apparatus for producing a consolidated, fiber-reinforced tape as given in claim 6, wherein the self-contained driving means comprises two opposing rollers being forced together by a variable-loading means.

14. An apparatus for producing a consolidated, fiber-reinforced tape as given in claim 13, wherein the variable-loading means is a pair of pneumatic air cylinders.

15. An apparatus for producing a consolidated, fiber-reinforced tape as given in claim 13, wherein the self-contained driving means is powered by an electric motor.

16. An apparatus for producing a consolidated, fiber-reinforced tape as given in claim 6, wherein the means for taking-up the consolidated, fiber-reinforced composite tape is a motorized spool.

17. An apparatus for producing a consolidated, fiber-reinforced tape as given in claim 6, wherein the impregnation bar assembly comprises a plurality of triangular-shaped ceramic bars.

18. An apparatus for producing a consolidated, fiber-reinforced tape as given in claim 6, wherein the impregnation bar assembly comprises three triangular-shaped ceramic bars, each bar being positioned substantially perpendicular to the axial direction of the plurality of fiber-reinforced tow bundles, each bar being oriented in series such that each bar contacts the plurality of fiber-reinforced tow bundles at a cross-sectional apex of each bar.

19. An apparatus for producing a consolidated, fiber-reinforced tape as given in claim 18, wherein the middle bar has a means for adjusting its height relative to the other two ceramic bars.

20. An apparatus for producing a consolidated, fiber-reinforced composite tape from a plurality of powder pre-impregnated fiber tow bundles, each fiber tow bundle having a filament array and a polymeric matrix, comprising:
(a) a pay-out creel for delivering the plurality of powder pre-impregnated fiber tow bundles to a collimation device;
(b) a collimation device, positioned in operable relationship to the pay-out creel, for aligning the tow bundles laterally;
(c) a processing component, positioned in operable relationship to the collimation device, for heating the tow bundles with an inert gas to a specific processing temperature which melts the polymeric matrix of the tow bundles, said processing component having an entrance and an exit, said processing component including an impregnation bar assembly positioned near the exit of the processing component for wetting-out the fibers of the heated tow bundles and for spreading the heated tow bundles to an initial width and shape;
(e) a variable dimension forming nip means, positioned in operable relationship to the processing component, for shaping the heated tow bundles into a precise, predetermined width, the variable dimension forming nip means having two rollers cooled by nitrogen, said rollers being forced together under a selected pressure by a pair of pneumatic air cylinders;
(f) a self-contained driving means, positioned in operable relationship to the variable-dimension forming nip means, for pulling the shaped tow bundles, said self-contained driving means having a second set of two rollers being forced together under a second selected pressure by a second pair of pneumatic air cylinders, said self-contained drive mechanism being powered by an electric motor and maintaining a constant speed across the width of the shaped tow bundles, thereby enabling the polymeric matrix of the shaped tow bundles to consolidate fully into the composite fiber-reinforced tape; and
(g) a motorized spool for taking-up the consolidated fiber-reinforced composite tape.
